(19) United States
(12) Patent Application Publication
(10) Pub. No.: US 2026/0336615 A1
(43) Pub. Date: Oct. 29, 2026

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Takahiro Shimizu, Tokyo (JP); Sho Tamura, Tokyo (JP)

(21) Appl. No.: 19/550,317

(22) Filed: Feb. 26, 2026

(30) Foreign Application Priority Data
Mar. 7, 2025 (JP) 2025-036453

(51) Int. Cl. B60W 30/12; G06V 20/56

(52) U.S. Cl. CPC B60W 30/12; G06V 20/588; B60W 2420/403; B60W 2420/408; B60W 2552/30; B60W 2552/53; B60W 2554/80; B60W 2556/40

(57) ABSTRACT

A vehicle control device of an embodiment includes a processor that executes instructions to: recognize first compartment lines based on an output of a first detection device, recognize second compartment lines based on map information, compare the first compartment lines with the second compartment lines at a predetermined comparison target distance in a moving direction of a vehicle, and perform driving control of the vehicle based on a comparison result, in which the processor sets, the other estimated compartment line based on one of the first compartment lines and the second compartment line out of inner and outer sides of a curved road, and reduces the comparison target distance when the degree of deviation between the other first compartment line and the estimated compartment line is equal to or less than a first threshold value.

### CROSS-REFERENCE TO RELATED APPLICATION

Priority is claimed on Japanese Patent Application No. 2025-036453, filed Mar. 7, 2025, the content of which is incorporated herein by reference.

### BACKGROUND

### Field of the Invention

The present invention relates to a vehicle control device, a vehicle control method, or a storage medium.

### Description of Related Art

In recent years, there have been increasing attempts to provide access to a sustainable transportation system that takes vulnerable traffic participants into consideration. In order to realize this effort, research and development into automated driving technologies have been focused on to further improve road safety and convenience. In relation to this, in recent years, technologies have become known for varying the control content of driving assistance depending on the reliability of compartment lines recognized by a compartment line recognizer, correcting the compartment lines obtained from a map based on road surface gradient information included in map information, and determining a vehicle's traveling lane based on results of comparison between the corrected compartment lines and compartment lines obtained from a camera (for example, Japanese Unexamined Patent Application, First Publication No. 2019-046363 and Japanese Unexamined Patent Application, First Publication No. 2024-088122).

### SUMMARY

Incidentally, in automated driving technology, when map information does not include road surface gradient information (or when the reliability of information is low), device compartment lines obtained from an output of a detection device such as a camera may not be appropriately compared with map compartment lines obtained from the map information. For this reason, there is a problem that appropriate driving control is not likely to be performed depending on surrounding road shapes.

In order to solve the above problem, one of objects of the present application is to provide a vehicle control device, a vehicle control method, and a storage medium which are capable of executing more appropriate driving control in accordance with surrounding road shapes. This will ultimately contribute to development of sustainable transportation systems.

A vehicle control device, a vehicle control method, and a storage medium according to the present invention adopt the following configurations.

(1) A vehicle control device according to one embodiment of the present invention includes a memory storing a instructions; and a processor configured to execute the instructions stored in the memory to: recognize, as first compartment lines, compartment lines that compart left and right sides of a traveling lane of a vehicle based on an output of a first detection device that detects compartment lines around the vehicle; recognize, as second compartment lines, compartment lines that compart the left and right sides of the traveling lane of the vehicle from map information, based on position information of the vehicle; compare the first compartment lines with the second compartment lines at a predetermined comparison target distance in a moving direction of the vehicle; and perform driving control of the vehicle based on a comparison result, wherein the processor sets, when a curved road is present in the traveling lane in the moving direction of the vehicle, the other estimated compartment line based on one of the first compartment lines and the second compartment line out of inner and outer sides of a curved road, and reduces the comparison target distance when the degree of deviation between the other first compartment line and the estimated compartment line is equal to or less than a first threshold value.

(2) In the aspect (1) above, the processor sets the estimated compartment line on the inner side of the curved road, based on the first and second compartment lines on the outer side of the curved road.

(3) In the aspect (2) above, the processor sets the estimated compartment line based on a deviation amount of a distance viewed from the vehicle with respect to the first and second compartment lines on the outer side of the curved road, and derives the degree of deviation between the set estimated compartment line and the first compartment line on the inner side of the curved road.

(4) In the aspect (3) above, the processor derives a difference in height in a vertical direction of the curved road with respect to a current position of the vehicle based on the deviation amount of the distance viewed from the vehicle with respect to the first and second compartment lines on the outer side of the curved road, and derives a deviation between the first compartment line on the inner side of the curved road and the estimated compartment line based on the derived difference in height.

(5) In the aspect (2) above, the processor maintains the reduced comparison target distance when the degree of deviation is greater than the first threshold value and is equal to or less than a second threshold value that is greater than the first threshold value, and the comparison target distance has already been reduced.

(6) In the aspect (5) above, the processor returns the comparison target distance to the distance before it was reduced when the degree of deviation is greater than the second threshold value and is equal to or less than a third threshold value that is greater than the second threshold value.

(7) In the aspect (6) above, the processor, when the degree of deviation is greater than the third threshold value, returns the comparison target distance to the distance before it was reduced, and suppresses changes in the comparison target distance for a predetermined period.

(8) In the aspect (1) above, the vehicle control device the processor further executes instructions to: recognize objects around the vehicle based on an output of a second detection device different from the first detection device, in which the processor performs driving control of the vehicle based on a comparison result between the second compartment line and the object recognized when the degree of deviation is equal to or less than the first threshold value.

(9) A vehicle control method according to another aspect of the present invention is a vehicle control method including causing a computer to recognize, as first compartment lines, compartment lines that compart left and right sides of a traveling lane of a vehicle based on an output of a first detection device that detects compartment lines around the vehicle, recognize, as second compartment lines, compartment lines that compart the left and right sides of the traveling lane of the vehicle from map information, based on position information of the vehicle, compare the first compartment lines with the second compartment lines at a predetermined comparison target distance in a moving direction of the vehicle, perform driving control of the vehicle based on a comparison result, set, when the curved road is present in the traveling lane in the moving direction of the vehicle, the other estimated compartment line based on one of the first compartment lines and the second compartment line out of inner and outer sides of a curved road, and reduce the comparison target distance when the degree of deviation between the other first compartment line and the estimated compartment line is equal to or less than a first threshold value.

(10) A storage medium according to still another aspect of the present invention is a computer-readable non-transitory storage medium storing a program that causes a computer to recognize, as first compartment lines, compartment lines that compart left and right sides of a traveling lane of a vehicle based on an output of a first detection device that detects compartment lines around the vehicle, recognize, as second compartment lines, compartment lines that compart the left and right sides of the traveling lane of the vehicle from map information, based on position information of the vehicle, compare the first compartment lines with the second compartment lines at a predetermined comparison target distance in a moving direction of the vehicle, perform driving control of the vehicle based on a comparison result, set, when the curved road is present in the traveling lane in the moving direction of the vehicle, the other estimated compartment line based on one of the first compartment lines and the second compartment line out of inner and outer sides of a curved road, and reduce the comparison target distance when the degree of deviation between the other first compartment line and the estimated compartment line is equal to or less than a first threshold value.

According to the above aspects (1) to (10), it is possible to execute more appropriate driving control in accordance with surrounding road shapes.

### BRIEF DESCRIPTION OF DRAWINGS

FIG. 1 is a configuration diagram of a vehicle system including a vehicle control device according to an embodiment.

FIG. 2 is a functional configuration diagram of a first controller and a second controller.

FIG. 3 is a diagram illustrating driving control of a vehicle in an embodiment.

FIG. 4 is a diagram illustrating differences in position when there is a road surface gradient.

FIG. 5 is a diagram illustrating a deviation between a device compartment line and a map compartment line on a road surface with a gradient in a moving direction of a vehicle.

FIG. 6 is a diagram illustrating a deviation between a device compartment line and a map compartment line on a curved road with a road surface gradient in a moving direction of a vehicle.

FIG. 7 is a diagram illustrating comparison between compartment lines when a curved road is present in a moving direction (forward) of a vehicle.

FIG. 8 is a diagram illustrating comparison between a device compartment line and an estimated compartment line.

FIG. 9 is a diagram illustrating an example of contents of comparison target distance setting information.

FIG. 10 is a flowchart showing an example of a flow of driving control processing in an embodiment.

FIG. 11 is a flowchart showing a first example of adjustment processing.

FIG. 12 is a flowchart showing a second example of adjustment processing.

### DESCRIPTION OF EMBODIMENTS

Hereinafter, embodiments of a vehicle control device, a vehicle control method, and a storage medium of the present invention will be described with reference to the accompanying drawings. An embodiment in which the vehicle control device is applied to an automated driving vehicle will be described below. For example, automated driving is an operation of executing driving control by automatically controlling one or both of steering and a speed of a vehicle. The above-described driving control may include various driving controls, such as an adaptive cruise control system (ACC), a lane keeping assistance system (LKAS), automated lane change (ALC), a traffic jam pilot (TJP), and a collision mitigation brake system (CMBS). In an automated driving vehicle, driving control (so-called manual driving) may be executed by a manual operation by a user (for example, a driver) of the vehicle. The vehicle control device in the embodiment may be applied to mobile objects other than vehicles, such as ships that can move on the ground like hovercrafts, flying bodies that can travel on roads, and stand-up vehicles that have power units.

### Overall Configuration

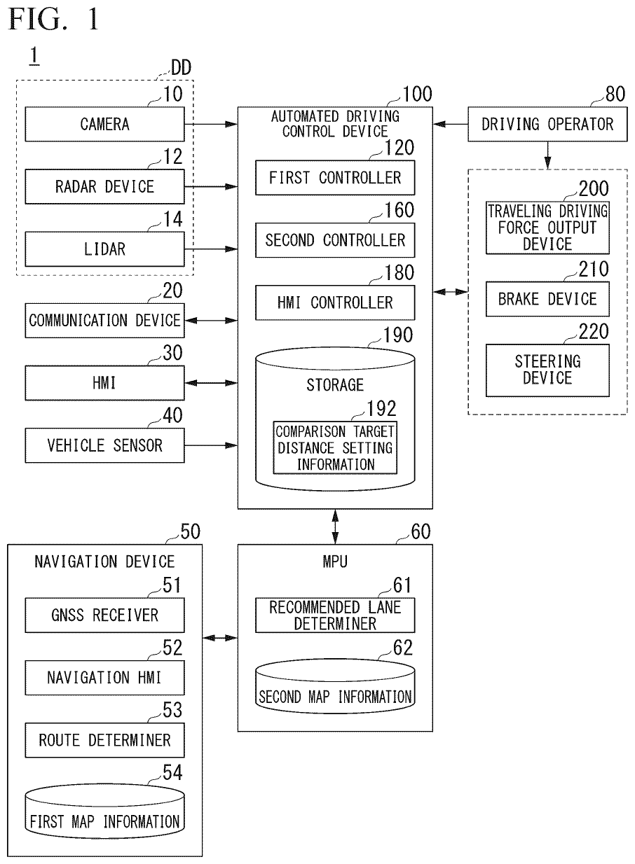

FIG. 1 is a configuration diagram of a vehicle system 1 including the vehicle control device according to the embodiment. A vehicle (hereinafter referred to as a vehicle M) in which the vehicle system 1 is mounted is, for example, a vehicle such as a two-wheeled vehicle, a three-wheeled vehicle, or a four-wheeled vehicle, or a micromobility, and a drive source thereof is an internal combustion engine such as a diesel engine or a gasoline engine, an electric motor, or a combination thereof. The electric motor operates using electric power generated by a power generator connected to the internal combustion engine or electric power that is supplied when a secondary battery (power storage) or a fuel cell is discharged.

The vehicle system 1 includes, for example, a camera 10, a radar device 12, a light detection and ranging (LIDAR) 14, a communication device 20, a human machine interface (HMI) 30, a vehicle sensor 40, a navigation device 50, a map positioning unit (MPU) 60, a driving operator 80, an automated driving control device 100, a traveling driving force output device 200, a brake device 210, and a steering device 220. These devices and equipment are connected to each other by multiple communication lines, such as a controller area network (CAN) communication line, serial communication lines, wireless communication networks, or the like. Further, the configuration illustrated in FIG. 1 is merely an example, and some of the configuration may be omitted, or other configuration may be added. The combination of the camera 10, the radar device 12, and the LIDAR 14 is an example of a “detection device DD.” The camera 10 is an example of a “first detection device”, and the radar device 12 is an example of a “second detection device”. The second detection device may include the LIDAR 14. The HMI 30 is an example of an “output device”. The automated driving control device 100 is an example of a “vehicle control device”.

For example, the camera 10 is a digital camera using a solid-state imaging element such as, for example, a charge-coupled device (CCD) or a complementary metal oxide semiconductor (CMOS). The camera 10 is attached to any location on the vehicle M in which the vehicle system 1 is mounted. For example, when the front side of the vehicle M is imaged, the camera 10 is attached to an upper part of a front windshield, a rear surface of a rearview mirror, a front part of a vehicle body, or the like. When the rear side of the vehicle M is imaged, the camera 10 is attached to an upper part of a rear windshield, a back door, or the like. When the side of the vehicle Mis imaged, the camera 10 is attached to a door mirror, or the like. The camera 10 captures images of the surroundings of the vehicle M repeatedly, for example, periodically. The camera 10 may also be a stereo camera.

The radar device 12 emits radio waves such as millimeter waves around the vehicle M and detects radio waves (reflected waves) reflected by a surrounding object to detect at least the position (distance and orientation) of the object. The radar device 12 is attached to the vehicle M at an arbitrary location. The radar device 12 may detect the position and speed of the object using a frequency modulated continuous wave (FM-CW) method.

The LIDAR 14 radiates light to the vicinity of the vehicle M and measures scattered light. The LIDAR 14 detects a distance to a subject based on a period of time between light emission and light reception. The emitted light is, for example, a pulsed laser beam. The LIDAR 14 is attached to an arbitrary position of the vehicle M.

The communication device 20 communicates with another vehicle located in the vicinity of the vehicle M, a terminal device of a user using the vehicle M, or various types of server devices by using a network such as a cellular network, a Wi-Fi network, Bluetooth (registered trademark), dedicated short-range communication (DSRC), a local area network (LAN), a wide area network (WAN), or the Internet.

The HMI 30 outputs various types of information to occupants (including the driver) of the vehicle M and receives input operations from the occupants. The HMI 30 includes, for example, a display and a speaker. The display is, for example, a liquid crystal display (LCD) or an organic electro luminescence (EL) display device. The display displays various types of images (including a video) in the embodiment. The display may be integrated with an input as a touch panel. The speaker outputs a predetermined sound (for example, a warning sound or a voice message). Furthermore, in addition to (or instead of) the display and the speaker, the HMI 30 may be a microphone, a buzzer, a touch panel, switches, keys, or the like. The switches include a switch for executing or terminating predetermined driving control (for example, ACC or LKAS) that can be executed by a driving controller to be described below, and a switch for approving (permitting) or rejecting driving control recommendations (proposals) from the system (vehicle system 1). The switches may also include a switch for performing direction indication operations (turn signal switch), and the like.

The vehicle sensor 40 includes a vehicle speed sensor configured to detect the speed of the vehicle M, an acceleration sensor configured to detect acceleration, a yaw rate sensor configured to detect a yaw rate (for example, a rotational angular velocity around a vertical axis passing through the center of gravity of the vehicle M), a direction sensor configured to detect the direction of the vehicle M, and the like. The vehicle sensor 40 may also be provided with a position sensor that detects the position of the vehicle. The position sensor is, for example, a sensor that acquires position information (longitude and latitude information) from a global positioning system (GPS) device. Further, the position sensor may be a sensor that acquires position information using a global navigation satellite system (GNSS) receiver 51 of the navigation device 50. The vehicle sensor 40 may derive the speed of the vehicle M from a difference (that is, a distance) in position information for a predetermined time in the position sensor. A detection result of the vehicle sensor 40 is output to the automated driving control device 100.

The navigation device 50 includes, for example, a GNSS receiver 51, a navigation HMI 52, and a route determiner 53. In the navigation device 50, first map information 54 is stored in a storage device such as a hard disk drive (HDD) or a flash memory. The GNSS receiver 51 specifies a position of the vehicle M based on the signal received from a GNSS satellite. The position of the vehicle M may be specified or supplemented by an inertial navigation system (INS) using the output of the vehicle sensor 40. The navigation HMI 52 includes a display device, a speaker, a touch panel, and keys. The GNSS receiver 51 may be provided in the vehicle sensor 40. The navigation HMI 52 may be partially or completely shared with the HMI 30 described above. The route determiner 53 determines, for example, a route (hereinafter, a route on map) to a destination input by an occupant using the navigation HMI 52 from the position of the vehicle M (or an arbitrary position that was input) specified by the GNSS receiver 51 with reference to the first map information 54. The first map information 54 is, for example, information in which road shapes are expressed by links indicating roads (an example of a moving route) and nodes connected by the links. The first map information 54 may include point of interest (POI) information, and the like. The route on map is output to the MPU 60. The navigation device 50 may perform route guidance using the navigation HMI 52 based on the route on map. The navigation device 50 may transmit the current position and destination to a navigation server via the communication device 20, and acquire the same route as the route on map from the navigation server. The navigation device 50 outputs a determined route on map to the MPU 60.

The MPU 60 includes, for example, a recommended lane determiner 61 and stores second map information 62 in a storage device such as an HDD or a flash memory. The recommended lane determiner 61 divides the route on map provided from the navigation device 50 into a plurality of blocks (for example, divides the route every 100 [m] in a vehicle moving direction), and determines a recommended lane for each block with reference to the second map information 62. The recommended lane determiner 61 determines which lane from the left the vehicle travels on. When there is a branching point in the route on map, the recommended lane determiner 61 determines a recommended lane such that the vehicle M can travel along a rational route for traveling to a branching destination.

The second map information 62 is map information more accurate than the first map information 54. The second map information 62 includes, for example, the number of lanes, the types and shapes of road compartment lines (hereinafter referred to as compartment lines), information on centers of lanes, and information on road boundaries. Examples of physical boundaries include soundproof walls, guardrails, fences, curbs, median strips, and tunnel side walls. The second map information 62 may include road shape information, traffic regulation information, address information (address and zip code), facility information, parking lot information, telephone number information, and the like. Road shape information is road shapes such as lane widths (road widths), branching points, merging points, and intersections. The road shape information may also include information on road curvature (which may be rephrased as a radius of curvature. The same applies below) and a curvature change amount (the curvature change amount per predetermined distance). The road shape information may also include information on a road surface gradient (a gradient in a road extension direction (longitudinal gradient), a gradient in a road width direction (horizontal direction) (horizontal gradient)) and road surface height information. The second map information 62 may be updated at any time by the communication device 20 communicating with an external device. The first map information 54 and the second map information 62 may be integrally provided as map information. The map information may be stored in a storage 190.

The driving operator 80 includes, for example, a steering wheel, an accelerator pedal, and a brake pedal. The driving operator 80 may include a shift lever, a modified steering wheel, a joystick, or other operators. An operation detector that detects an amount of operation with respect to the operator by the occupant or presence or absence of the operation, for example, is attached to each operator of the driving operator 80. The operation detector detects, for example, a steering angle or steering torque of the steering wheel, and an amount of depression of the accelerator pedal or the brake pedal. The operation detector outputs detection result to one or both of the automated driving control device 100, and the travel driving force output device 200, the brake device 210 and the steering device 220.

The automated driving control device 100 executes various driving controls related to automated driving for the vehicle M. The automated driving control device 100 includes, for example, a first controller 120, a second controller 160, an HMI controller 180, and the storage 190. The first controller 120, the second controller 160, and the HMI controller 180 are implemented, for example, by causing a hardware processor such as a central processing unit (CPU) to execute a program (software). Further, some or all of these components may be realized by hardware (including circuitry) such as a large scale integration (LSI), an application specific integrated circuit (ASIC), a field-programmable gate array (FPGA), a graphics processing unit (GPU), or a system on chip (SOC), or may be realized by a combination of software and hardware. The program may be pre-stored in a storage device (a storage device including a non-transitory storage medium) such as an HDD or a flash memory of the automated driving control device 100 or may be stored in a removable storage medium such as a DVD, a CD-ROM, or a memory card and installed in the storage device of the automated driving control device 100 when the storage medium (the non-transitory storage medium) is mounted in a drive device, a card slot, or the like.

The storage 190 may be implemented by the above-described various storage devices an electrically erasable programmable read-only memory (EEPROM), a read-only memory (ROM), a random-access memory (RAM), or the like. The storage 190 stores, for example, comparison target distance setting information 192, programs, and various other information. Details of the comparison target distance setting information 192 will be described later. The storage 190 may store map information (for example, the first map information 54 and the second map information 62).

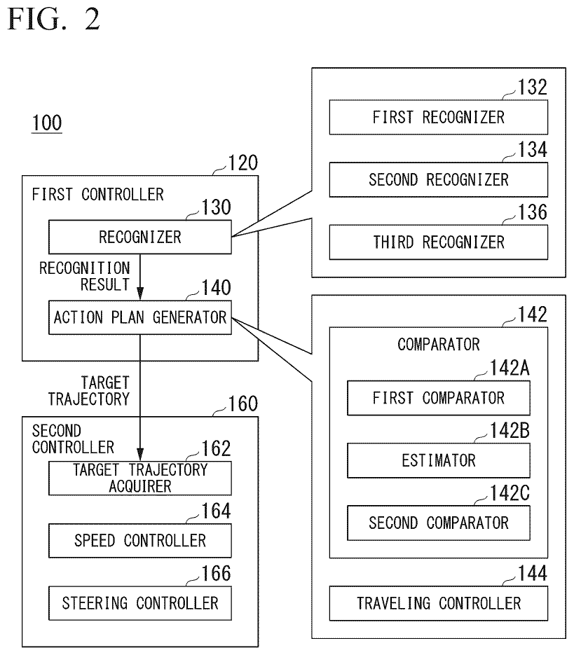

FIG. 2 is a functional configuration view of the first controller 120 and the second controller 160. The first controller 120 includes, for example, a recognizer 130 and an action plan generator 140. The first controller 120 performs functions based on, for example, artificial intelligence (AI) and a pre-defined model in parallel. For example, a function of “recognizing an intersection” may be realized by executing in parallel recognition of an intersection by deep learning or the like and recognition based on pre-given conditions (such as signals and road signs that can be pattern matched), and by scoring and comprehensively evaluating both. Accordingly, reliability of automated driving is guaranteed. The first controller 120 executes control related to automated driving of the vehicle M based on, for example, instructions from the MPU 60, the HMI controller 180, and the like.

The recognizer 130 recognizes the surrounding circumstances of the vehicle M based on recognition results of the detection device DD (information input from the camera 10, the radar device 12, and the LIDAR 14). For example, the recognizer 130 recognizes conditions such as the position, speed, and acceleration of objects around (within a predetermined distance from) the vehicle M. Objects include traffic participants such as other vehicles, pedestrians, and bicycles, and physical boundaries that compart roads (moving routes). The position of the object, for example, is recognized as a position on absolute coordinates having a representative point of the vehicle M (the center of gravity, a drive shaft center, or the like) as the origin, and is used for control. The position of the object may be represented by a representative point on the object such as the center of gravity or a corner thereof or may be represented by an expressed region. For example, when the object is a mobile object such as another vehicle, the “state” of the object includes acceleration, jerk, or an “action state” (for example, the other vehicle is changing lanes or is about to change lanes) of the mobile object.

The recognizer 130 recognizes, for example, temporary stop lines, obstacles, red traffic lights, toll gates, other road events, marks (speed limits) marked on roads, and road signs on which the speed limits are marked. The recognizer 130 may also recognize road boundaries, the positions and shapes of buildings around roads, and the like. The recognizer 130 includes, for example, a first recognizer 132, a second recognizer 134, and a third recognizer 136. Details of these functions will be described below.

The action plan generator 140 generates an action plan for causing the vehicle M to travel by automated driving based on the recognition results of the recognizer 130, and the like. For example, the action plan generator 140 travels, in principle, in the recommended lane determined by the recommended lane determiner 61, and further, based on the recognition results of the recognizer 130 and the like, generates a target trajectory (target traveling route) for the vehicle M to travel automatically (without relying on the driver's operation) in the future so that the vehicle M can respond to the surrounding circumstances of the vehicle M. For example, the target trajectory includes a speed element. For example, the target trajectory is represented as a sequence of points (trajectory points) that the vehicle M should reach. The trajectory point is a point that the vehicle M should reach for a predetermined traveling distance (for example, a few meters) along the road, and in addition, the target speed and target acceleration are generated as part of the target trajectory for each predetermined sampling time (for example, a few tenths of a second). In addition, the trajectory point may be the position that the vehicle M should reach at a predetermined sampling time for each predetermined sampling period of time. In this case, information on the target speed and target acceleration is expressed as an interval between trajectory points.

The action plan generator 140 may set automated driving events when generating a target trajectory. Events include, for example, a constant speed driving event in which the vehicle M travels in the same lane at a constant speed, a following traveling event corresponding to ACC which causes the vehicle M to follow another vehicle that is within a predetermined distance (for example, within 100 [m]) ahead of the vehicle M and is closest to the vehicle M, a lane maintenance traveling event corresponding to LKAS which causes the vehicle M to travel in the center of the traveling lane, a lane change event corresponding to ALC which causes the vehicle M to change lanes from its own lane to an adjacent lane, a branching event in which the vehicle M branches into a lane on a destination side at a road branching point, a merging event in which the vehicle M merges into a main lane at a merging point, and a takeover event in which automated driving ends and switches to manual driving. Examples of the events may include an overtaking event in which the vehicle M first changes lanes into an adjacent lane, overtakes a preceding vehicle in the adjacent lane, and then changes the lanes again to the original lane, and an avoidance event in which the vehicle M performs at least one of braking and steering in order to avoid an obstacle present in front of the vehicle M.

For example, the action plan generator 140 may change an event already determined for a current section to another event, or set a new event for the current section, in accordance with the surrounding circumstances of the vehicle M recognized when the vehicle M is traveling. The action plan generator 140 may change the event already set for the current section to another event, or set a new event for the current section, in accordance with an operation of an occupant with respect to the HMI 30. The action plan generator 140 generates a target trajectory according to the set event. The action plan generator 140 includes, for example, a comparator 142 and a traveling controller 144. Furthermore, the comparator 142 includes, for example, a first comparator 142A, an estimator 142B, and a second comparator 142C. Details of these functions will be described below.

The second controller 160 controls the traveling driving force output device 200, the brake device 210, and the steering device 220 so that the vehicle M passes through the target trajectory generated by the action plan generator 140 at the scheduled time. The traveling controller 144 and the second controller 160 are examples of a “driving controller”.

The second controller 160 includes, for example, a target trajectory acquirer 162, a speed controller 164, and a steering controller 166. The target trajectory acquirer 162 acquires information on the target trajectory (trajectory points) generated by the action plan generator 140 and stores the information on the target trajectory in a memory (not shown). The speed controller 164 controls the traveling driving force output device 200 or the brake device 210 based on the speed element associated with the target trajectory stored in the memory. The steering controller 166 controls the steering device 220 according to the curvature of the target trajectory stored in the memory. The processing of the speed controller 164 and the steering controller 166 is realized, for example, by a combination of feed-forward control and feedback control. For example, the steering controller 166 performs control in combination of feed-forward control based on a curvature of a road in front of the vehicle M and feedback control based on a deviation from the target trajectory.

Referring back to FIG. 1, the HMI controller 180 notifies an occupant of the vehicle M of predetermined information by using the HMI 30. The predetermined information includes, for example, information on the traveling of the vehicle M, such as information on the state of the vehicle M and information on driving control. The information on the state of the vehicle M includes, for example, a speed, an engine speed, a shift position, and the like of the vehicle M. The information on the driving control includes, for example, whether driving control is executed by automated driving, information for inquiring about whether to start automated driving, information on the state of driving control through automated driving, information on a driving mode, information for prompting an occupant to perform driving when switching from automated driving to manual driving, and the like. The predetermined information may include information on the surrounding circumstances recognized by the detection device DD. The predetermined information may include information that is not related to traveling of the vehicle M, such as a television program, contents (for example, movies) stored in a storage medium such as a DVD. The predetermined information may include, for example, information on a current position, a destination, and a remaining amount of fuel of the vehicle M in the automated driving. The HMI controller 180 may output information received by the HMI 30 to the communication device 20, the navigation device 50, the first controller 120, and the like.

The HMI controller 180 may cause the HMI 30 to output inquiry information for an occupant, processing results by the first controller 120 and the second controller 160, and the like. The HMI controller 180 may transmit various types of information output to the HMI 30 to a terminal device used by the occupant of the vehicle M via the communication device 20.

The traveling driving force output device 200 outputs a traveling driving force (torque) to the driving wheels so that the vehicle travels. The driving force output device 200 includes, for example, a combination of an internal combustion engine, an electric motor, a transmission, and an electronic controller (ECU) that controls these. The ECU controls the above-described components in accordance with information input from the second controller 160 or information input from the accelerator pedal of the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor in accordance with the information input from the second controller 160 or the information input from the brake pedal of the driving operator 80 so that brake torque according to a braking operation is output to each wheel. The brake device 210 may include a mechanism configured to transfer the hydraulic pressure generated according to an operation on the brake pedal to the cylinder via a master cylinder as a backup. Further, the brake device 210 is not limited to the configuration described above, but may be an electronically controlled hydraulic brake device that controls the actuator according to information input from the second controller 160 and transmits the hydraulic pressure of the master cylinder to the cylinder.

The steering device 220, for example, includes a steering ECU and an electric motor. The electric motor, for example, applies a force to a rack and pinion mechanism to change the direction of steered wheels. The steering ECU drives the electric motor in accordance with the information input from the second controller 160 or the information input from the steering wheel of the driving operator 80 to change the direction of the steered wheels.

### Recognizer, Comparator, and Driving Controller

Next, details of driving control of the vehicle M based on the functions of the recognizer 130 (mainly the first recognizer 132, the second recognizer 134, and the third recognizer 136), the comparator 142, and the driving controller (mainly the traveling controller 144) will be described.

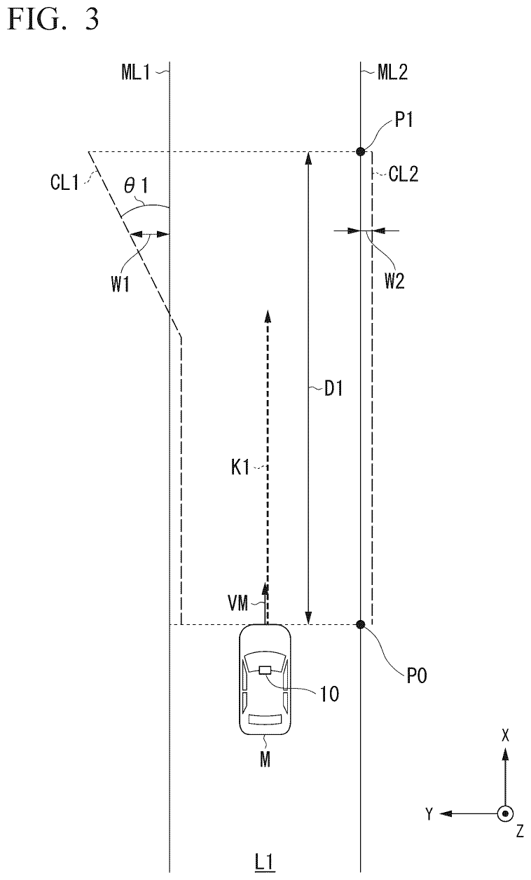

FIG. 3 is a diagram illustrating driving control of the vehicle M according to the embodiment. The example of FIG. 3 shows device compartment lines CL1, CL2 recognized by the detection device DD and map compartment lines ML1, ML2 obtained from map information (for example, the second map information 62) based on the position information of the vehicle M. For example, in the map information, a lane L1 is defined by the map compartment lines ML1, ML2. The lane L1 illustrated in FIG. 3 is a road on which the vehicle can move in its extension direction (the X-axis direction in the drawing), and has a road shape with no road surface gradient (the degree of a gradient is less than a predetermined value) and no curves (bends) in the moving direction (the curvature is less than a predetermined value). Hereinafter, when there is no need to distinguish between the device compartment lines CL1, CL2, they will simply be referred to as “device compartment lines CL”, and when there is no need to distinguish between the map compartment lines ML1, ML2, they will simply be referred to as “map compartment lines ML”. The device compartment line CL is an example of a “first compartment line”, and the map compartment line ML is an example of a “second compartment line”. In the scene illustrated in FIG. 3, the vehicle M is traveling on the lane L1 at a speed VM in the extension direction.

In the example of FIG. 3, the first recognizer 132 recognizes the surrounding circumstances of the vehicle M based on the output of the detection device DD that detects the surrounding circumstances (external world) of the vehicle M. For example, the first recognizer 132 recognizes, based on an image (hereinafter referred to as a camera image) captured by the camera 10, left and right compartment lines as viewed from the vehicle M that comparts surrounding lanes including the moving direction of the vehicle M, as device compartment lines CL. For example, the first recognizer 132 performs known analysis processing on the camera image (for example, edge extraction, extraction of feature data such as a color, a shape, and a size, pattern matching processing, and character recognition processing), and recognizes, from image analysis results, the device compartment lines CL along which the vehicle M is traveling. When recognizing the device compartment lines CL, the first recognizer 132 extracts edge points having a large difference in brightness from adjacent pixels in the camera image, and recognizes the device compartment lines CL in an image plane by connecting the edge points. The first recognizer 132 converts the position of the device compartment line CL based on the position of a representative point of the vehicle M into a vehicle coordinate system (for example, XY plane coordinates where the front direction of the vehicle M is the X axis and the vehicle width direction (lateral direction) is the Y axis as illustrated in FIG. 3).

In the example of FIG. 3, the first recognizer 132 recognizes device compartment lines CL1, CL2 based on camera images. While the example of FIG. 3 shows the device compartment lines CL1, CL2 located within a predetermined distance ahead (moving direction) of the vehicle M, device compartment lines on the sides and rear of the vehicle M may also be recognized. The first recognizer 132 may recognize the curvature of the lane L1 based on camera images, or may recognize curvature change amounts of the device compartment lines CL1, CL2. The curvature change amounts are, for example, the rates of change over time of the curvatures of the device compartment lines CL1, CL2 recognized by the camera 10 at a distance x [m] ahead as viewed from the vehicle M. The first recognizer 132 may also recognize the device compartment lines CL1, CL2 based on outputs of detection devices (for example, the radar device 12 and the LIDAR 14) other than the camera 10, or may correct the device compartment lines CL1, CL2 obtained from camera images. The first recognizer 132 may recognize objects (camera objects) present around the vehicle M (within a predetermined distance) by performing the above-mentioned analysis processing on the camera images.

The second recognizer 134 recognizes lane compartment lines around the vehicle M from map information based on, for example, the position of the vehicle M detected by the vehicle sensor 40 or the GNSS receiver 51. For example, the second recognizer 134 recognizes, as the map compartment lines ML, the left and right compartment lines of the vehicle M that comparts the lane L1 in which the vehicle M travels, with reference to map information (the first map information 54 and the second map information 62) based on the position information of the vehicle M acquired by the vehicle sensor 40 or the GNSS receiver 51. In the example of FIG. 3, the second recognizer 134 recognizes the map compartment lines ML1, ML2 based on the map information. The second recognizer 134 may also recognize the curvatures and gradients of the lanes L1 and L2 from the map information, or may recognize curvature change amounts of the map compartment lines ML1, ML2.

The third recognizer 136 recognizes objects (for example, fences, guardrails, soundproof walls, walls of surrounding buildings, and the like) around the vehicle M based on the output of a second detection device that detects the surrounding circumstances of the vehicle M. For example, the third recognizer 136 recognizes objects (radar objects) that are present in the vicinity of the vehicle M including the moving direction of the vehicle M, based on detection results of the radar device 12, which is an example of a second detection device. For example, the third recognizer 136 extracts, by clustering, an object group that exists in close proximity (within a predetermined distance) from detection results (radar object group) obtained by the radar device 12, and recognizes the positions (shapes) of objects (radar objects) that exist in front of or to the side of the vehicle M based on extraction results. The third recognizer 136 may also recognize a distance between the vehicle M and an object, a direction in which the object exists as viewed from the vehicle M, and the like. The third recognizer 136 may recognize objects within the lane L1 (for example, other vehicles, median strips, and the like) by distinguishing them from objects outside the lane L1, and may recognize objects that are at a standstill (stationary objects) by distinguishing them from objects that are moving (moving objects).

Instead of (or in addition to) the radar device 12, the third recognizer 136 may recognize the position, distance, direction, and the like of objects in front of or to the side of the vehicle M based on detection results obtained by the LIDAR 14, which is an example of a second detection device. The third recognizer 136 may correct information (position, and the like) on objects detected by the radar device 12 or the LIDAR 14 based on information on objects (camera objects) recognized by the first recognizer 132.

The first comparator 142A compares, for example, the device compartment lines CL recognized by the first recognizer 132 with the map compartment lines ML recognized by the second recognizer 134. For example, the first comparator 142A performs comparison between left-side compartment lines for comparing the device compartment line CL1 comparting the left side of the traveling lane L1 with the map compartment line ML1, and comparison between right-side compartment lines for comparing the device compartment line CL2 comparting the right side of the traveling lane L1 with the map compartment line ML2, in a section (comparison target range) from the current position (point P0 in the drawing) of the vehicle M to a position (point P1 in the drawing) a predetermined comparison target distance D1 away in the moving direction (forward). Here, the comparison target distance D1 may be, for example, a distance to the farthest point of the device compartment lines CL1, CL2 that can be recognized by the detection device DD using the first recognizer 132, or may be a fixed distance. The comparison target distance D1 may also be adjusted in accordance with a road shape, such as a road with a curve (hereinafter referred to as a curved road) or a road surface gradient, or may be adjusted in accordance with the degree of deviation between the device compartment line CL and the map compartment line ML. A specific example of setting the comparison target distance D1 will be described later.

For example, the first comparator 142A performs comparison between the device compartment line CL1 and the map compartment line ML1 for at least one of a position, an extension direction (angle), a curvature, and a curvature change amount, as the comparison between left-side compartment lines in the section (range) from the vehicle M to the comparison target distance D1. For example, the first comparator 142A superimposes the device compartment line CL1 and the map compartment line ML1 on each other based on the position of a representative point of the vehicle M on the plane of the vehicle coordinate system (XY plane), and compares the lateral positions (lane width direction, Y-axis direction in the drawing) of the device compartment line CL1 and the map compartment line ML1 to derive a deviation width W1. The deviation width W1 may be, for example, a maximum value or average value of a shift over the comparison target distance D1.

The first comparator 142A may also compare the extension directions of the device compartment line CL1 and the map compartment line ML1 to derive a deviation angle θ1 between the compartment lines. The deviation angle θ1 may be a maximum angle or average angle of a shift over the comparison target distance D1. The first comparator 142A may also compare the curvature or curvature change amounts of the device compartment line CL1 and the map compartment line ML1 to derive the degree (magnitude) of a difference in curvature change amount. The first comparator 142A derives the degree of deviation based on at least one piece of information among the deviation width W1, the deviation angle θ1, and the degree of difference in curvature (curvature change amount). In this case, the first comparator 142A increases the degree of deviation, for example, as the deviation width W1 increases, as the deviation angle θ1 increases, or as the degree of difference in curvature (curvature change amount) increases.

Similarly to the comparison between left-side compartment lines, the first comparator 142A performs comparison between the device compartment line CL2 and the map compartment line ML2 for at least one of a position (deviation width W2 in the drawing), a deviation angle, a curvature, and a curvature change amount to acquire the degree of deviation, as the comparison between right-side compartment lines over the comparison target distance D1. The first comparator 142A may also combine a comparison result for the left-side compartment lines and a comparison result for the right-side compartment lines to derive the degree of deviation between the device compartment line CL and the map compartment line ML.

The traveling controller 144 performs driving control for the vehicle M based on the recognition results of the recognizer 130 and the comparison results of the first comparator 142A. For example, the traveling controller 144 determines driving control for the vehicle M based on the above-mentioned recognition results and comparison results, and generates a target trajectory based on the determined driving control. “Determining the driving control” may include determining the content (type) of the driving control or determining whether to execute (suppress) the driving control. “Executing the driving control” may include continuing the driving control that is already being executed, in addition to switching the content of the driving control and executing the driving control. “Suppressing the driving control” may include not only not executing the driving control, but also lowering the mode (automation level) of the driving control.

Here, the driving control includes a first driving mode and a second driving mode in which the degree of driving assistance is lower than in the first driving mode or a task load of an occupant of the vehicle M is greater than in the first driving mode. The low degree of driving assistance means, for example, a low automation rate in driving control. The low automation rate means, for example, that the automated driving control device 100 has a low degree of control over the steering or speed of the vehicle M (the driver has a high degree of need to intervene in steering or acceleration/deceleration operations). The great task load of the occupant includes, for example, a large number of tasks assigned to the occupant or tasks of a high severity. The task may be, for example, monitoring the surroundings of the vehicle M or the occupant operating the driving operator 80. Operations of the driving operator 80 include setting a state in which the driver grips the steering wheel (hereinafter referred to as a hands-on state). The driving control may also include a third driving mode that provides a lower level of driving assistance than the second driving mode or imposes a greater task load on the occupant of the vehicle M than the second driving mode. A driving mode that provides the lowest level of driving assistance or imposes the greatest task load on the occupant of the vehicle M may be a fully manual driving mode (a mode in which driving control is not executed).

In the following description, the first driving mode allows driving control (for example, ACC, LKAS, ALC, TJP, CMBS, and the like) in a state in which no task load is imposed on an occupant (or the lightest task load) and an occupant of the vehicle Mis not gripping the steering wheel (hereinafter referred to as a hands-off state). The second driving mode includes tasks assigned to an occupant, such as monitoring the surroundings of the vehicle M and setting a hands-on state.

During execution of the first driving mode (for example, driving control in a hands-off state), the traveling controller 144 continues the first driving mode when, as results of the comparison between the left-side compartment lines and the comparison between the right-side compartment lines within the comparison target range, the degree of deviation between both the compartment lines is less than a threshold value. For example, when the traveling controller 144 is executing LKAS control to travel in the center of the traveling lane L1 as the first driving mode and the degree of deviation between both the compartment lines is less than a threshold value, the traveling controller 144 generates a target trajectory K1 for traveling in the center of the traveling lane L1 based on the device compartment lines CL1, CL2 or the map compartment lines ML1, ML2, and causes the second controller 160 to execute control so as to travel along the generated target trajectory K1.

During execution of the second driving mode, the traveling controller 144 may perform control to switch from the second driving mode to the first driving mode when the degree of deviation between the compartment lines over the comparison target distance D1 is less than a threshold value. In this case, when performing switching control, the traveling controller 144 may cause the HMI 30 to output information indicating that switching to an occupant is possible or inquiring about whether to perform switching (or information suggesting switching), and may switch the driving mode when information indicating permission for switching is received from the occupant. After the HMI 30 gives an instruction to switch to the first driving mode, the traveling controller 144 may switch from the second driving mode to the first driving mode at a timing when the degree of deviation between the left and right compartment lines falls below a threshold value.

The traveling controller 144 may suppress driving control in the first driving mode when the degree of deviation between the compartment lines in the comparison target range is equal to or greater than the threshold value. For example, when the first driving mode is being executed and the degree of deviation between the compartment lines in the comparison target range is equal to or greater than the threshold value, the traveling controller 144 executes driving control to switch from the first driving mode to the second driving mode.

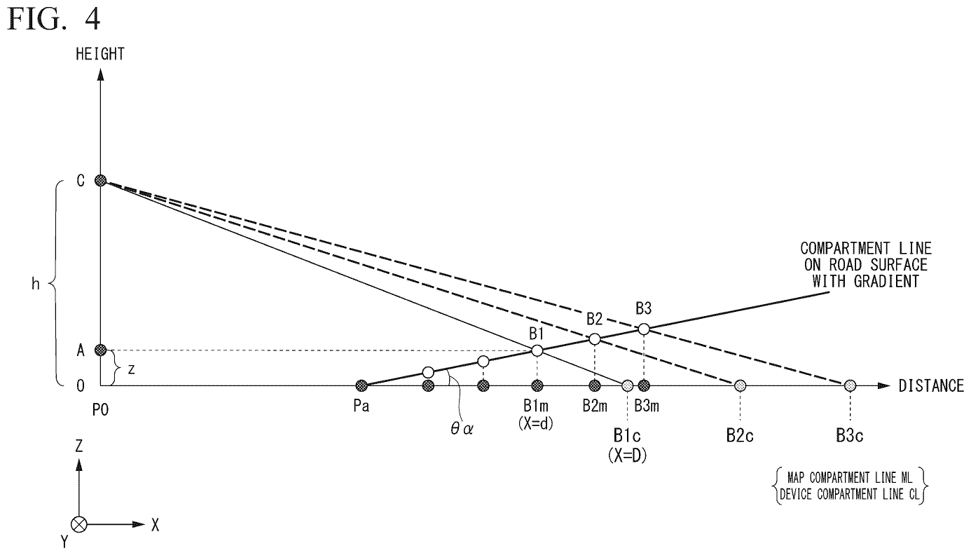

Here, when the traveling lane in the moving direction of the vehicle M has a road surface gradient or a curved road, the accuracy of recognition is decreased due to the device compartment lines CL1, CL2 being affected by the gradient or curve (curvature), thereby increasing the degree of deviation between the device compartment lines CL1, CL2 and the map compartment lines ML1, ML2. FIG. 4 is a diagram illustrating differences in position when there is a road surface gradient. In the example of FIG. 4, the horizontal axis represents a distance from the vehicle M, and the vertical axis represents a height from a road surface. The distance may represent a distance from the position of the vehicle M to the device compartment line CL or a distance from the position of the vehicle M to the map compartment line ML. In FIG. 4, O indicates the current position of the vehicle M (the position of the road surface), and C indicates the position of the camera 10 mounted on the vehicle M. In FIG. 4, it is assumed that there is a road surface gradient (an upward slope of a longitudinal gradient) with a gradient angle θα with respect to a horizontal plane from a point Pa in the moving direction (forward) of the vehicle M. In the example of FIG. 4, the map compartment line ML is shown without including road surface gradient information.

As illustrated in FIG. 4, when an actual compartment line (a compartment line on a road surface with a gradient) is viewed from a height h of the camera 10 mounted on the vehicle M, a distance from a point B1 at a certain height z to a position B1m on the map compartment line ML is d. The height z indicates a difference in height in a vertical direction with respect to the current position of the vehicle M. On the other hand, when viewed from camera 10, the point B1 appears to be located at an actual position B1 on the plane due to the influence of the gradient of the actual road surface, and the distance thereof is D. For this reason, when recognizing the same point, a deviation amount (D-d) of a distance occurs between the device compartment line CL and the map compartment line ML. This deviation amount increases as a distance from the vehicle M increases, as illustrated in FIG. 4, for a relationship between a position B2m on the map compartment line ML and a position B2c on the device compartment line CL for a point B2, and for a relationship between a position B3m on the map compartment line ML and a position B3c on the device compartment line CL for point B3.

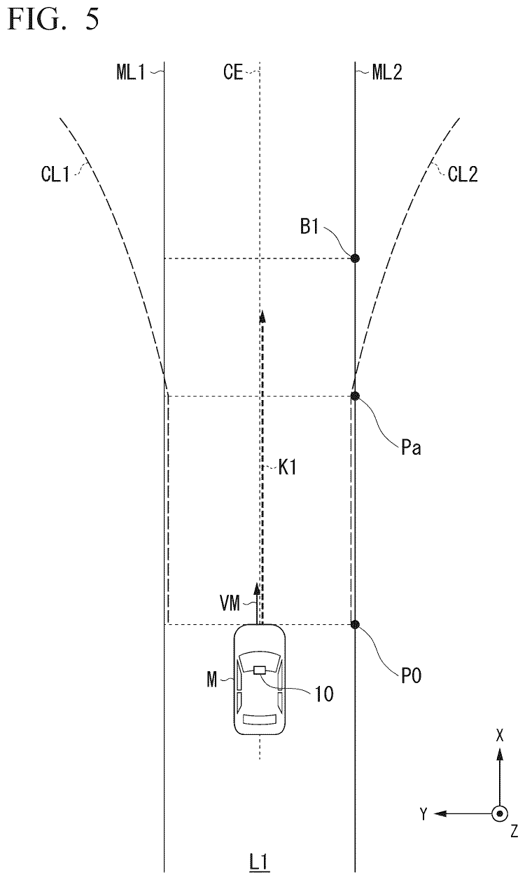

FIG. 5 is a diagram illustrating a deviation between the device compartment line CL and the map compartment lines ML on a road surface that has a gradient in the moving direction of the vehicle M. In the example of FIG. 5, a part of the content illustrated in FIG. 4 is shown as a vehicle coordinate system (XY plane coordinates). For example, when a road surface has a gradient in a section ahead of the point Pa as viewed from the vehicle M, the device compartment line CL1 and the map compartment line ML1, and the device compartment line CL2 and the map compartment line ML2, which compart the lane L1 as illustrated in FIG. 5, will deviate from each other due to a distance shift (deviation amount) illustrated in FIG. 4, and the deviation amount increases as a distance from the vehicle M increases.

Here, when a road with a road surface gradient is a straight road as illustrated in FIG. 5, deviation amounts (shift amounts) of the left and right compartment lines of the lane L1 will change the same (uniform), and thus a center CE between the left and right compartment lines in the compartment lines will be at substantially the same position. Thus, when driving control such as LKAS is executed, the target trajectory K1 is generated such that the vehicle travels in the center CE of the lane L1, and thus there is no significant impact even when driving control such as LKAS is executed.

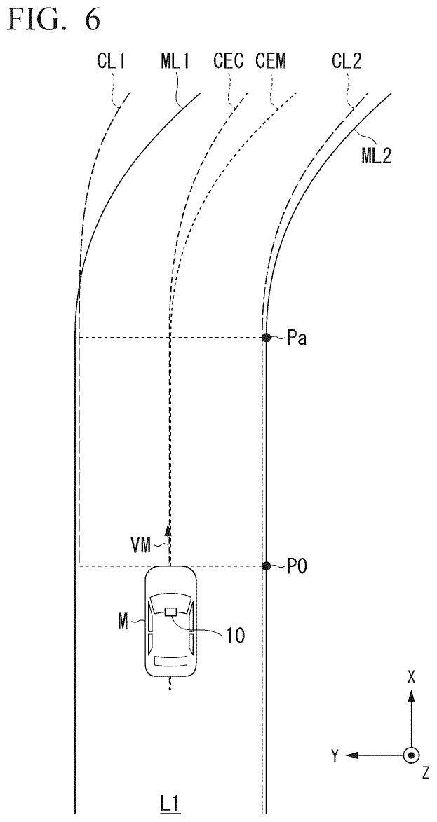

However, when traveling on a curved road with a curvature equal to or greater than a predetermined value, a shift amount between the left and right sides becomes uneven. FIG. 6 is a diagram illustrating a deviation between the device compartment line CL and the map compartment lines ML on a curved road with a road surface gradient in the moving direction of the vehicle M. As illustrated in FIG. 6, when a curved road with a road surface gradient is present in the moving direction of the vehicle M, the degree of change in a deviation amount (shift amount) of each of the left and right compartment lines that compart the lane L1 in which the vehicle M is traveling is different (uneven). For this reason, a center CEM of a lane comparted by the map compartment lines ML1, ML2 is positioned at a location different from a center CEC of a lane comparted by the device compartment lines CL1, CL2. In this case, the device compartment lines CL1, CL2 are shifted due to the road surface gradient, and the vehicle travels based on the map compartment lines ML1, ML2. However, when there is no road surface gradient information, it is not possible to determine that the device compartment lines CL1, CL2 have been shifted due to the road surface gradient. For this reason, in the related art, when a first driving mode (hands-off state) is being executed in a scene as illustrated in FIG. 6, there is no option but to perform control for switching to a second driving mode (hands-on state) (lowering a level), which results in a decrease in continuity of driving control. Information on a road surface gradient or a road surface height may not be stored in map information, or the information may not be highly accurate.

Consequently, in the embodiment, in a scene as illustrated in FIG. 6, the presence or absence of a road surface gradient in a moving direction is estimated based on the device compartment lines CL and the map compartment lines ML, and driving control in the first driving mode (hands-off state) or the like is executed (continued) through control based on an estimation result. As illustrated in FIGS. 5 and 6, on a road with a road surface gradient, the degree of deviation between the device compartment line CL and the map compartment line ML increases as a distance from the vehicle M increases. Thus, in the embodiment, when it is estimated that there is a road surface gradient, comparison between the compartment lines may be performed by reducing a comparison target distance (range). Thereby, in a section with a road surface gradient, the device compartment lines CL and the map compartment lines ML are compared in a range near the vehicle M, thereby reducing the degree of deviation and making it difficult to suppress the execution of the first driving mode, and thus it is possible to improve the continuity of driving control in the first driving mode.

### Estimation of Presence or Absence of Road Surface Gradient

Next, estimation of a road surface gradient will be described. Hereinafter, processing in a case where a curved road is present in a traveling lane in the moving direction of the vehicle M will be described as an example. For example, as illustrated in FIG. 6, when a curved road is present in the traveling lane in the moving direction of the vehicle M, the estimator 142B estimates the presence or absence of a road surface gradient from a shift amount (deviation amount) between the positions B1m and B1c illustrated in FIG. 4. Here, when the height (A) of the road surface at the point B1 from the current position (point P0) of the vehicle M is z, ΔAB1C and ΔOB1cC illustrated in FIG. 4 are similar to each other. Thus, a relationship AC:AB1=OC:OB1c, that is, a relationship “(h−z):d=h:D”, is established. From this relationship, “D/d=h/(h−z)” is derived. Here, h is a constant value because it is the height of the camera 10 that is mounted, d is a predetermined value (for example, 30, 40, . . . , 150 [m]), and D is a distance detected from a camera image. Thus, the estimator 142B derives a height z of a road surface (a difference in the height of a curved road in a vertical direction with respect to the current position of the vehicle) by using the above formula. The estimator 142B determines that there is a road surface gradient when the derived height z is greater than a predetermined value, and estimates that there is no road surface gradient when it is equal to or less than the predetermined value. The above-described estimation processing is performed using either the left or right compartment line.

When a curved road is present in the traveling lane in the moving direction of the vehicle M, the estimator 142B sets, based on one of the device compartment lines CL and the map compartment line ML out of an inner side (inner side of a turn) and an outer side (outer side of a turn) of the curved road, an estimated compartment line obtained by estimating the other compartment line (for example, the device compartment line). The second comparator 142C then compares the other device compartment line CL with the estimated compartment line set by the estimator 142B, and performs adjustment processing such as reducing a comparison target distance when the degree of deviation is equal to or less than a threshold value. The above-described processing may be executed when the estimator 142B determines that the above-mentioned height z is greater than a predetermined value and there is a road surface gradient, instead of (or in addition to) when a curved road is present in the traveling lane in the moving direction of the vehicle M. The first comparator 142A compares the device compartment line CL with the map compartment line ML based on the reduced comparison target distance.

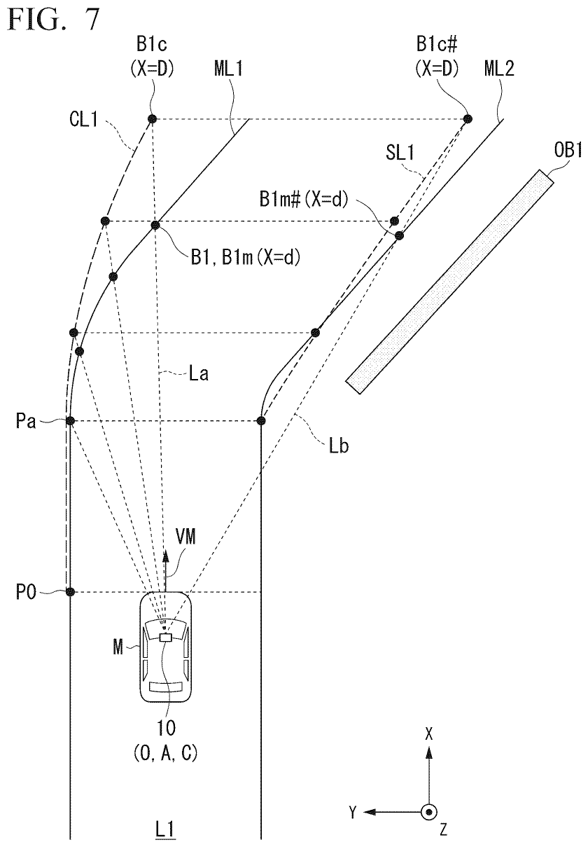

FIG. 7 is a diagram illustrating comparison of compartment lines when a curved road is present in the moving direction (forward) of the vehicle M. In the example of FIG. 7, the lane L1 in which the vehicle Mis traveling has a curved road with a curvature equal to or greater than a predetermined value after a point Pa in the moving direction (forward) of the vehicle M. In the example of FIG. 7, it is assumed that there is a road surface gradient (longitudinal gradient) in a section after the point Pa. In the example of FIG. 7, it is assumed that the vehicle M is traveling toward the curved road at a speed VM from a point P0 (horizontal plane) ahead of the point Pa where the road surface gradient occurs. The example of FIG. 7 shows map compartment lines ML1, ML2 that compart the lane L1, a device compartment line CL1 on the left side (the outer side of the curved road) as viewed from the vehicle M, and an estimated compartment line SL1 on the right side (the inner side of the curved road) as viewed from the vehicle M. The estimated compartment line SL1 is, for example, an estimated value (predicted value) of the device compartment line on the inner side of the curved road, which is derived based on the device compartment line CL1 on the outer side of the curved road and the map compartment line ML1.

In the example of FIG. 7, it is assumed that an object OB1 is located on the outer right side (rear right side) of the lane L1 as viewed from the vehicle M. The object OB1 may be a physical boundary such as a guardrail, a fence, or a soundproof wall, or may be a building that is present around the lane L1. The object OB1 is recognized by the third recognizer 136. Symbols (signs) O, A, C, B1, B1m, and B1c illustrated in FIG. 7 correspond to the symbols illustrated in FIG. 4. A straight line La indicates the direction of a point B1 (a recognition direction of a position B1c) as viewed from the position (O, A, C) of the vehicle M illustrated in FIG. 4 on the compartment line on the left side of the vehicle M (the compartment line on the outer side of the curved road), and a straight line Lb indicates the direction of the point B1 as viewed from the position (O, A, C) of the vehicle M on the compartment line on the right side of the vehicle M (the compartment line on the inner side of the curved road).

Here, in the embodiment, it is assumed that the curved road has a road surface gradient. In this case, it is assumed as a precondition that the influence of the road surface gradient is the same on the inner side and outer side of the curved road. That is, it is assumed that a deviation amount between the device compartment line CL1 and the map compartment line ML1 on a road surface with a gradient as illustrated in FIG. 4 occurs on each of the left and right compartment lines. Thus, in a relationship between the map compartment line ML2 and the estimated compartment line SL1 on the inner side of the curved road, a ratio of “AB1m#:OB1c #” on the straight line Lb is equal to a ratio of “AB1m:OB1c” on the straight line La.

Based on the above-described precondition, the estimator 142B derives the straight line La connecting a position C of the camera 10 and a predetermined value d (for example, 30, 40, . . . , 150 [m]) on the map compartment line ML1 with respect to the device compartment line CL1 recognized by the first recognizer 132 on the outer side of the curved road, and derives intersections (for example, B1c, B2c, B3c, and the like illustrated in FIG. 4) between the straight line La and the device compartment line CL1. The estimator 142B also derives the straight line Lb connecting the position C of the camera 10 and a predetermined value d (for example, 30, 40, . . . , 150 [m]) on the map compartment line ML2 on the inner side of the curved road, and derives a position B1c # that is offset at a ratio based on the precondition with respect to a position B1m # on the straight line Lb corresponding to the predetermined value d. The estimator 142B then sets a line connecting the positions B1c # derived for the respective predetermined value d as the estimated compartment line SL1. The positions B1c # may be connected by a straight line, or by a curve that corresponds to the curvature of the curved road recognized by the first recognizer 132 or the second recognizer 134.

In the example of FIG. 7, the estimated compartment line SL1 on the inner side of the curved road is derived based on the device compartment line CL1 and the map compartment line ML1 on the outer side of the curved road, but the estimated compartment line on the outer side of the curved road may also be derived based on the device compartment line CL2 and the map compartment line ML2 on the inner side of the curved road. However, since a deviation amount (in other words, the value of the ratio in the precondition) is greater on the outer side of the curved road than on the inner side, the accuracy of estimation of the estimated compartment line SL1 can be improved by deriving the estimated compartment line SL1 on the inner side of the curved road based on the device compartment line CL1 and the map compartment line ML1 on the outer side of the curved road.

When the curvature of the compartment line on the outer side of the curved road and the curvature of the compartment line on the inner side can be separately recognized, the estimator 142B may correct the position or shape (curvature and the like) of the set estimated compartment line SL1 in accordance with a difference in each of the curvatures. Thereby, it is possible to improve the accuracy of estimation of the estimated compartment line SL1.

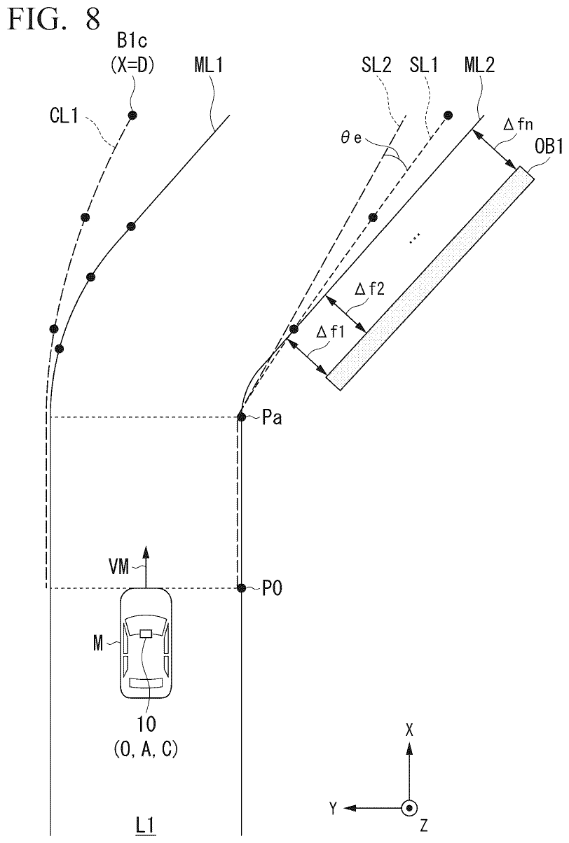

Next, the second comparator 142C compares the device compartment line CL2 on the inner side of the curved road with the estimated compartment line SL1. FIG. 8 is a diagram illustrating comparison between the device compartment line CL2 and the estimated compartment line SL1. In the example of FIG. 8, the second comparator 142C derives an angle (deviation angle) θe between a direction in which the device compartment line CL2 extends and a direction in which the estimated compartment line SL1 extends from the same point (for example, a point Pa), for example. When the deviation angle θe is equal to or less than a first threshold value, the second comparator 142C determines that the assumption that the curved road has a road surface gradient is correct (probable) (that is, it is estimated that there is a road surface gradient). The traveling controller 144 then determines, based on the comparison by the comparator 142 described above, that the device compartment line CL and the map compartment line ML have deviated due to the road surface gradient, and executes the first driving mode (or continues the first driving mode when it is currently being executed).

When a deviation angle θe is equal to or less than the first threshold value, the second comparator 142C makes a comparison target distance shorter than a reference distance. The reduction in distance may be performed by subtracting a predetermined fixed distance from the reference distance, may be performed by reducing the distance to a predetermined distance shorter than the reference distance, or may be performed by reducing the distance at a predetermined ratio (for example, 50%) with respect to the current distance. The reduction in distance may be performed by subtracting a distance corresponding to the speed VM of the vehicle M, may be performed by reducing a distance corresponding to the degree of a gradient (for example, the magnitude of the height z illustrated in FIG. 4), or may be performed by reducing a distance corresponding to a curvature.

Through the above-described processing, it is possible to estimate the presence or absence of a road surface gradient even in a situation where gradient information or height information has not been acquired from map information. When there is a road surface gradient, the degree of deviation between the device compartment line CL and the map compartment line ML increases as a distance from the vehicle M increases. Thus, when it is estimated that the curved road has a road surface gradient, the first comparator 142A derives the degree of deviation within a reduced range by reducing a comparison target distance, increasing a possibility that the degree of deviation will be less than a threshold value, thereby making it easier to execute (continue) the first driving mode.

When the deviation angle θe between the estimated compartment line SL1 and the device compartment line CL2 is large, the second comparator 142C determines that the assumption that the curved road has a road surface gradient is incorrect (that is, it is estimated that there is no road surface gradient). In this case, it is assumed that the degree of deviation becomes larger due to a cause other than the road surface gradient, and thus the traveling controller 144 suppresses execution of the first driving mode. For example, the traveling controller 144 performs control to switch from the first driving mode (hands-off state) to the second driving mode (hands-on state), or performs control to prevent switching from the second driving mode to the first driving mode. Thereby, it is possible to achieve more appropriate driving control in accordance with road conditions.

In the embodiment, the second comparator 142C may set a plurality of threshold values for the deviation angle de and perform different control (adjustment) on a comparison target distance depending on determination conditions for the set threshold values and the deviation angle θe. Information on the determination conditions and the like may be stored in the storage 190 or the like as comparison target distance setting information 192, or may be acquired from an external device via the communication device 20.

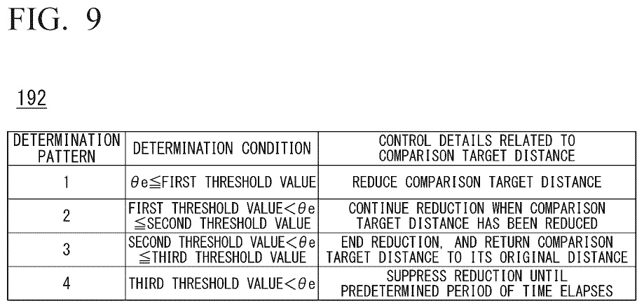

FIG. 9 is a diagram illustrating an example of the content of the comparison target distance setting information 192. In the comparison target distance setting information 192, for example, determination conditions are associated with control details related to a comparison target distance. The comparison target distance setting information 192 may also include information for identifying each determination condition (for example, identification information of a determination pattern). The control details for each determination pattern will be described below.

### Determination Pattern 1

A condition for Determination Pattern 1 is that a deviation angle θe is equal to or less than a first threshold value. When the condition for Determination Pattern 1 is satisfied, the second comparator 142C makes a comparison target distance shorter than a reference distance. The first comparator 142A compares the device compartment lines CL with the map compartment line ML at the reduced distance.

### Determination Pattern 2

A condition for Determination Pattern 2 is that a deviation angle θe is greater than the first threshold value and equal to or less than a second threshold value. The second threshold value is greater than the first threshold value. When the condition for Determination Pattern 2 is satisfied and the comparison target distance has already been reduced at the present time, the second comparator 142C continues the state of reduction. When the condition for Determination Pattern 2 is satisfied and the comparison target distance has not yet been reduced at the present time, the second comparator 142C suppresses a reduction in the comparison target distance. The first comparator 142A compares the device compartment lines CL with the map compartment lines ML at the current comparison target distance. Thereby, it is possible to suppress unnecessary control by maintaining the current comparison target distance when the deviation angle θe is relatively large.

### Determination Pattern 3

A condition for Determination Pattern 3 is that a deviation angle θe is greater than the second threshold value and equal to or less than a third threshold value. The third threshold value is a value greater than the second threshold value. When the condition for Determination Pattern 3 is satisfied and the comparison target distance has already been reduced at the present time, the second comparator 142C ends the reduction in the comparison target distance and returns the comparison target distance to its original distance (the reference distance before reduction). When the condition for Determination Pattern 3 is satisfied and the comparison target distance has not yet been reduced at the present time, the second comparator 142C suppresses a reduction in the comparison target distance. The first comparator 142A compares the device compartment lines CL with the map compartment lines ML at the original distance (reference distance). Thereby, when the deviation angle θe is large, it is possible to perform appropriate control by resetting the comparison target distance.

### Determination Pattern 4

A condition for Determination Pattern 4 is that a deviation angle θe is greater than the third threshold value. When the condition for Determination Pattern 4 is satisfied, and the comparison target distance has already been reduced at the present time, the second comparator 142C ends the reduction in the comparison target distance and returns the comparison target distance to its original distance (the reference distance before reduction). Furthermore, the second comparator 142C suppresses a change in the comparison target distance (for example, prohibits the comparison target distance from being reduced again) for a predetermined period after the reduction is ended (for example, until the vehicle M travels approximately 100 [m], or until a predetermined period of time elapses). Thereby, it is possible to suppress variations in control caused by frequent changes in the comparison target distance. When the condition for Determination Pattern 4 is satisfied and the comparison target distance has not yet been reduced at the present time, the second comparator 142C suppresses a reduction in the comparison target distance.

The determination conditions in the embodiment and the control processing when the determination conditions are satisfied are not limited to the examples described above. As described above, it is possible to adjust the comparison target distance in accordance with the magnitude of the deviation angle de by varying the content of control by a plurality of determination patterns, and to improve the continuity of driving control, which is being currently executed, by comparing compartment lines with reduced distances.

In the embodiment, when the degree of deviation between the estimated compartment line SL1 and the map compartment line ML2 is equal to or less than a first threshold value, the first comparator 142A may compare the map compartment line ML2 with information on surrounding objects recognized by the third recognizer 136, and determine whether the map compartment line ML2 has been correctly recognized based on a comparison result.

In this case, based on the degree of parallelism between the position (shape) of an object OB1 recognized by the third recognizer 136 and the shape of the map compartment line ML2 over a predetermined distance, the first comparator 142A derives the degree of deviation between the compartment line and the object. The predetermined distance may be, for example, a distance corresponding to a range from the vehicle M to a comparison target distance, or may be a fixed distance. For example, as illustrated in FIG. 8, the first comparator 142A acquires lateral widths Δf1, Δf2, . . . , Afn at predetermined intervals in extension directions of the object OB1 and the map compartment line ML2. The first comparator 142A then derives the degree of parallelism based on a difference between maximum and minimum values among the acquired plurality of widths Δf1, Δf2, . . . , Δfn. In this case, the first comparator 142A increases the degree of parallelism as the difference decreases. Instead of (or in addition to) the difference between the maximum and minimum values, the first comparator 142A may acquire information on the stability of the width Δf (the number of times the width Δf increases or decreases, or the degree of the amount of increase or decrease), and derive the degree of parallelism based on the acquired stability. In this case, the first comparator 142A increases the degree of parallelism as the stability increases. A method of deriving the degree of parallelism in the embodiment is not limited to the above-described example, and other methods may be used. The first comparator 142A decreases the degree of deviation as the degree of parallelism increases.

When the degree of deviation between the map compartment line ML2 and the object OB1 is equal to or less than a threshold value, the first comparator 142A determines that the map compartment line ML2 has been correctly recognized. When the degree of deviation is greater than the threshold value, the first comparator 142A determines that the map compartment line ML2 has not been correctly recognized. When the first comparator 142A determines that the map compartment line ML2 has been correctly recognized, the traveling controller 144 generates a target trajectory for continuing a first driving mode (LKAS or the like) based on the map compartment lines ML1 and ML2, and causes the vehicle M to drive along the generated target trajectory. When it is determined that the map compartment line ML2 has not been correctly recognized, the traveling controller 144 switches to second driving control if the first driving mode is being executed, and suppresses switching to the first driving mode if the second driving control is being executed. Thereby, it is possible to grasp the accuracy of the map compartment line ML and to execute more appropriate control based on the results.

### MODIFICATION EXAMPLES

In the above-described embodiment, a case has been described in which there is an upward gradient (upward slope) in the moving direction of the vehicle M, but similar processing (control) may also be executed for a downward gradient (downward slope). In the above-described embodiment, when a curved road is present in the moving direction of the vehicle M, an estimated compartment line is set based on the other compartment line out of compartment lines on the inner and outer sides of the curved road, and the set estimated compartment line is compared with the other compartment line. However, similarly, for road shapes other than the curved road, an estimated compartment line may also be set based on one of left and right compartment lines and compared with the other compartment line. Thereby, actual compartment lines can be recognized more accurately using the estimated compartment lines. Thus, driving control is executed based on information on more accurately recognized compartment lines, making it possible to perform more appropriate driving control and improve the continuity of driving control.

In the embodiment, even when a lateral gradient is included, an estimated compartment line may be set from one of left and right compartment lines in consideration of the magnitude of the lateral gradient, the set estimated compartment line may be compared with the other compartment line, and driving control of the vehicle M may be performed based on a comparison result. In the embodiment, when map information referred to in processing (for example, map information stored in the storage 190) does not store information on a road surface gradient or information on height information (in the case of a two-dimensional map), driving control may be executed using the above-described processing. In the embodiment, when the map information includes gradient information or height information, the comparator 142 may correct the device compartment line CL recognized by the first recognizer 132 based on the gradient information and height information acquired from the map information, and may compare the corrected device compartment line with a map compartment line. In the embodiment, the above-described various controls may be performed in predetermined driving control including not only the above-described LKAS control but also other controls (for example, ACC control and the like).

### Processing Flow

Hereinafter, processing executed by the automated driving control device 100 of the embodiment will be described. In the following, among processes executed by the automated driving control device 100, driving control processing will be mainly described based mainly on recognition results of compartment lines, and the like. The processing shown below may be repeatedly executed at a predetermined timing or predetermined cycles.

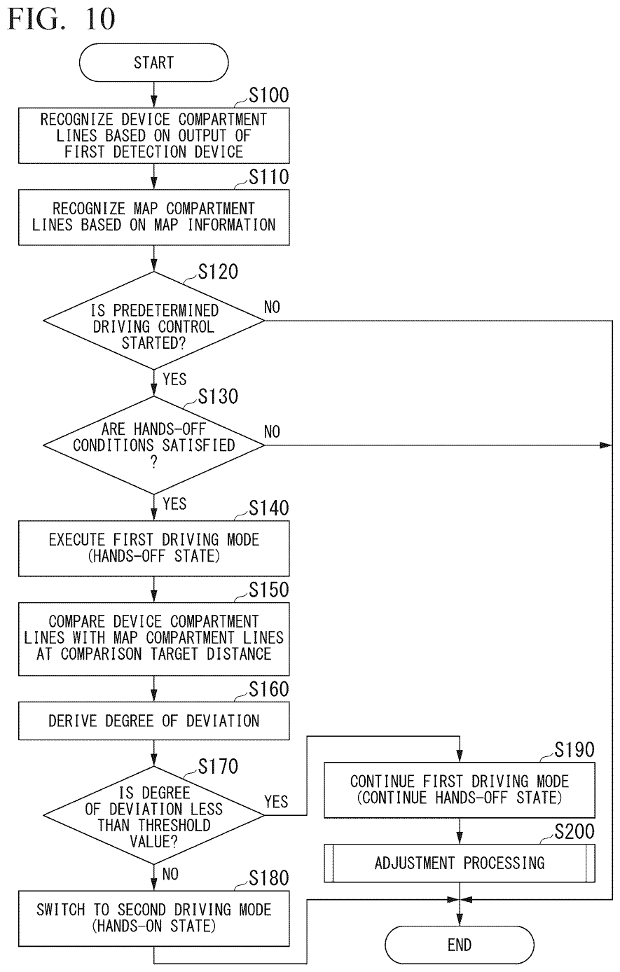

FIG. 10 is a flowchart showing an example of a flow of the driving control processing in the embodiment. In the example of FIG. 10, the first recognizer 132 recognizes the surrounding circumstances including compartment lines (device compartment lines CL) that are present around the vehicle M, based on an output of the first detection device (step S100). Next, the second recognizer 134 refers to map information based on the position information of the vehicle M and recognizes compartment lines (map compartment lines ML) that are present around the vehicle M from the map information (step S110).

Next, the traveling controller 144 determines whether to start predetermined driving control (step S120). The predetermined driving control refers to driving control in which the steering, speed, and the like of the vehicle M are controlled based on the recognized compartment lines, and includes, for example, LKAS control and ACC control. The predetermined driving control may be started, for example, when an instruction to execute the predetermined driving control is received by operating the HMI 30 by an occupant of the vehicle M, or when the surrounding circumstances recognized by the first recognizer 132 satisfy the conditions for starting the predetermined driving control.

When it is determined that the predetermined driving control is started, the traveling controller 144 determines whether hands-off conditions are satisfied (step S130). When it is determined that the hands-off conditions are satisfied, the traveling controller 144 executes the first driving mode in which a hands-off state is possible (step S140). In the processing of step S140, for example, when LKAS control is executed as the first driving mode, the traveling controller 144 generates a target trajectory for the vehicle M to pass through the center of the traveling lane comparted by the recognized left and right device compartment lines CL or map compartment lines ML, and causes the second controller 160 to execute steering control and speed control of the vehicle M so that the vehicle M travels along the generated target trajectory.

Next, the comparator 142 compares the device compartment lines with the map compartment lines at a comparison target distance (step S150). Next, the comparator 142 derives the degree of deviation (step S160) and determines whether the derived degree of deviation is less than a threshold value (step S170). When it is determined that the degree of deviation is not less than the threshold value, traveling control is performed (step S180). When it is determined in the processing of step S170 that the degree of deviation is less than the threshold value, the traveling controller 144 continues the first driving mode (hands-off state) (step S190). Next, the comparator 142 performs processing of adjusting the comparison target distance (step S200). The processing of step S200 may be executed, for example, when a curved road is present in the traveling lane in the moving direction of the vehicle M. Details of the processing of step S200 will be described below. Thereby, the processing of this flowchart ends. When it is determined in the processing of step S120 that the predetermined driving control is not started, or when it is determined in the processing of step S130 that the hands-off conditions are not satisfied, the processing of this flowchart ends.

Next, the processing of adjusting the comparison target distance in step S200 will be described. The following describes two separate examples.

### Adjustment Processing: First Example

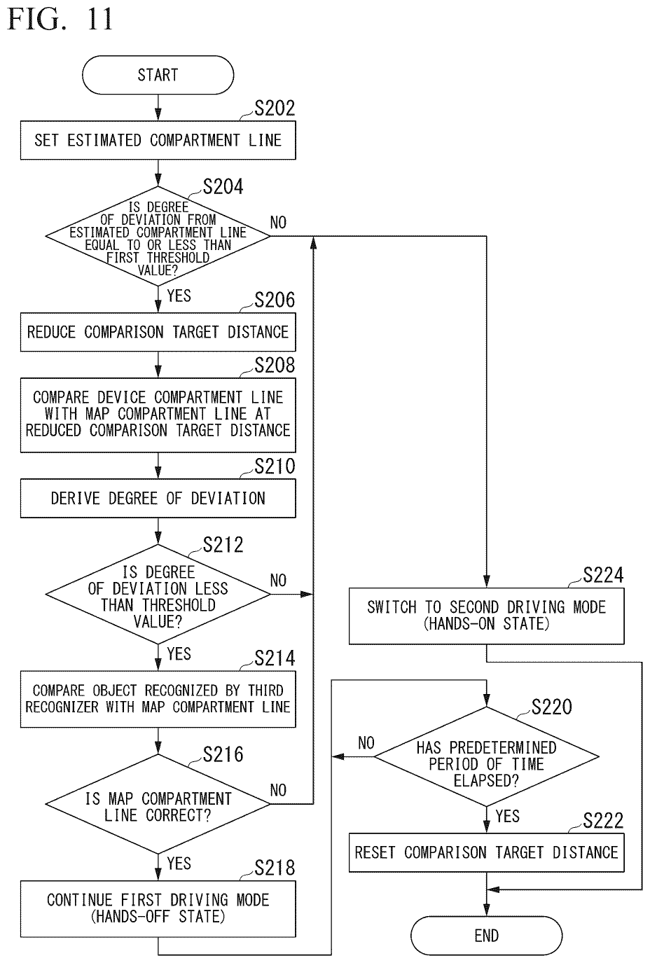

Next, FIG. 11 is a flowchart showing a first example of the adjustment processing. In the example of FIG. 11, when a curved road is present in the traveling lane in the moving direction of the vehicle M, the comparator 142 sets an estimated compartment line based on one of the device compartment lines and the map compartment line out of the inner and outer sides of the curved road (step S202). Next, the comparator 142 determines whether the degree of deviation between the set estimated compartment line and the other device compartment line is equal to or less than a first threshold value (step S204). When the comparator 142 determines that the degree of deviation is equal to or less than the first threshold value, the comparator 142 reduces the comparison target distance (step S206) and compares the device compartment line with the map compartment line within the reduced distance range (step S208). Next, the comparator 142 derives the degree of deviation at the comparison target distance (step S210) and determines whether the derived degree of deviation is less than a threshold value (step S212). When it is determined that the degree of deviation is less than the threshold value, the comparator 142 compares an object recognized by the third recognizer 136 with the map compartment line (step S214) and determines whether the map compartment line is correct based on a comparison result (step S216). When it is determined that the map compartment line is correct, the traveling controller 144 continues the first driving mode based on the map compartment line (step S218).

Next, the comparator 142 determines whether a predetermined period of time has elapsed since the comparison target distance has been reduced (step S220), and when the predetermined period of time has elapsed, the comparator 142 resets the comparison target distance (returns it to the distance before it was reduced) (step S222). Thereby, the processing of this flowchart ends. When it is determined in the processing of step S204 that the degree of deviation from the estimated compartment line is not equal to or less than the threshold value, when it is determined in the processing of step S212 that the degree of deviation is not less than the threshold value, or when it is determined in the processing of step S216 that the map compartment line is incorrect, the traveling controller 144 executes control to switch to the second driving mode (hands-on state) (step S224). Thereby, the processing of this flowchart ends.

### Adjustment Processing: Second Example

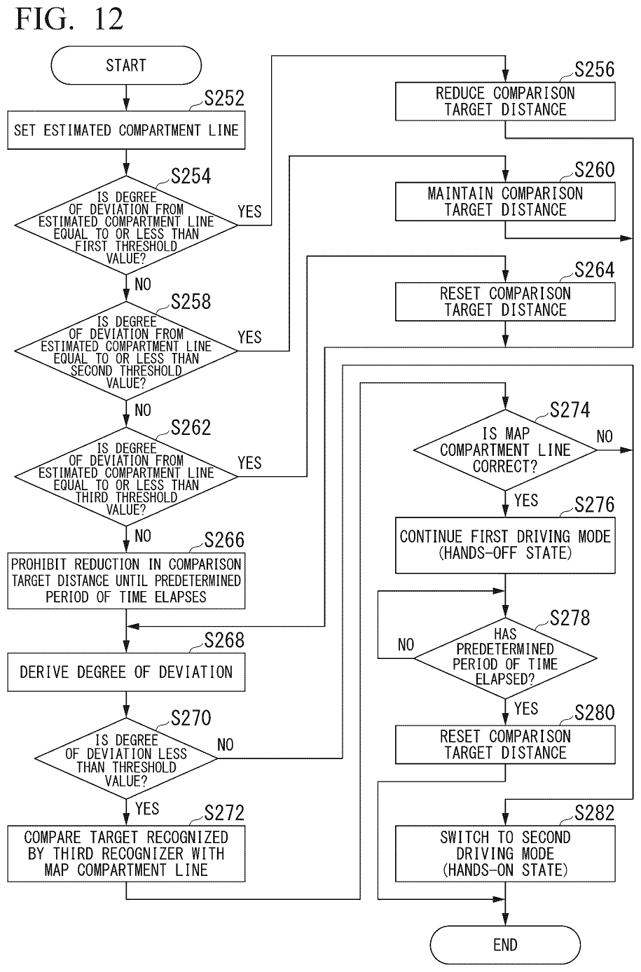

Next, FIG. 12 is a flowchart showing a second example of the adjustment processing. In the example of FIG. 12, when a curved road is present in the traveling lane in the moving direction of the vehicle M, the comparator 142 sets an estimated compartment line based on one of the device compartment lines and the map compartment line out of the inner and outer sides of the curved road (step S252). Next, the comparator 142 determines whether the degree of deviation between the set estimated compartment line and the other device compartment line is equal to or less than a first threshold value (step S254). When the comparator 142 determines that the degree of deviation is equal to or less than the first threshold value, the comparator 142 reduces the comparison target distance (step S256). When the degree of deviation from the estimated compartment line is not equal to or less than the first threshold value in the processing of step S254, the comparator 142 determines whether the degree of deviation from the estimated compartment line is equal to or less than a second threshold value (step S258). When it is determined that the degree of deviation from the estimated compartment line is equal to or less than the second threshold value, the comparator 142 maintains the current comparison target distance (step S260). When it is determined in the processing of step S258 that the degree of deviation from the estimated compartment line is not equal to or less than the second threshold value, the comparator 142 determines whether the degree of deviation from the estimated compartment line is equal to or less than a third threshold value (step S262). When it is determined that the degree of deviation is equal to or less than the third threshold value, the comparator 142 resets the current comparison target distance (returns it to the distance before it was reduced) (step S264). When it is determined in the processing of step S262 that the degree of deviation from the estimated compartment line is not equal to or less than the third threshold value, the comparator 142 prohibits the comparison target distance from being reduced until a predetermined period has elapsed since the determination (step S266).

After the processing of step S256, S260, S264, or S266, the comparator 142 derives the degree of deviation between the device compartment line and the map compartment line based on the adjusted comparison target distance (step S268) and determines whether the derived degree of deviation is less than a threshold value (step S270). When it is determined that the degree of deviation is less than the threshold value, the comparator 142 compares an object recognized by the third recognizer 136 with the map compartment line (step S272) and determines whether the map compartment line is correct based on a comparison result (step S274). When it is determined that the map compartment line is correct, the traveling controller 144 continues the first driving mode based on the map compartment line (step S276).

Next, when the comparison target distance has been reduced, the comparator 142 determines whether a predetermined period of time has elapsed since the comparison target distance has been reduced (step S278), and when the predetermined period of time has elapsed, the comparator 142 resets the comparison target distance (returns it to the distance before it was reduced) (step S280). Thereby, the processing of this flowchart ends. When the processing of step S270 determines that the degree of deviation is not less than the threshold value, or when the processing of step S274 determines that the map compartment line is incorrect, the traveling controller 144 executes control to switch to the second driving mode (hands-on state) (step S282). Thereby, the processing of this flowchart ends.

As described above, according to the above-described embodiment, the automated driving control device 100 (an example of a vehicle control device) includes the first recognizer 132 that recognizes, as device compartment lines (first compartment lines), compartment lines that compart left and right sides of a traveling lane of a vehicle M, based on an output of a first detection device that detects compartment lines around the vehicle M, the second recognizer 134 that recognizes, as map compartment lines (second compartment lines), the compartment lines that compart the left and right sides of the traveling lane of the vehicle M from map information based on position information of the vehicle M, the comparator 142 that compares the device compartment lines with the map compartment lines at a predetermined comparison target distance in a moving direction of the vehicle M, and a driving controller (the traveling controller 144, the second controller 160) that performs driving control of the vehicle M based on a comparison result of the comparator 142. When a curved road is present in the traveling lane in the moving direction of the vehicle M, the comparator 142 sets an estimated compartment line based on one of the device compartment lines and the map compartment line out of the inner and outer sides of the curved road, and reduces the comparison target distance when the degree of deviation between the device compartment line and the estimated compartment line on the other side is equal to or less than a first threshold value, thereby making it possible to execute more appropriate driving control in accordance with the shapes of the surrounding roads. This can ultimately contribute to development of sustainable transportation systems.

According to the embodiment, it is possible to detect a deviation between a device compartment line and a map compartment line due to a road surface gradient without using map information. According to the embodiment, in a situation where a deviation between a device compartment line and a map compartment line due to a road surface gradient occurs, the degree of deviation can be reduced by reducing a comparison target distance (monitoring range) of the compartment lines, thereby improving the continuity of driving control.

According to the embodiment, the comparison target distance can be adjusted in accordance with the degree of deviation between an estimated compartment line and a map compartment line, and thus it is possible to compare compartment lines under more appropriate conditions. For this reason, it is possible to execute more appropriate driving control. According to the embodiment, the accuracy of compartment lines can be evaluated based on surrounding objects detected by a radar device or the like, and thus it is possible to more accurately recognize the compartment lines. Thus, it is possible to more improve the continuity of driving control based on information on the recognized compartment lines.

The embodiment described above can be expressed as below. A vehicle control device including:
a storage medium storing computer-readable instructions; and
a processor connected to the storage medium,
the processor executing the computer-readable instructions to
recognize, as first compartment lines, compartment lines that compart left and right sides of a traveling lane of a vehicle based on an output of a first detection device that detects compartment lines around the vehicle,
recognize, as second compartment lines, compartment lines that compart the left and right sides of the traveling lane of the vehicle from map information, based on position information of the vehicle,
compare the first compartment lines with the second compartment lines at a predetermined comparison target distance in a moving direction of the vehicle,
perform driving control of the vehicle based on a comparison result,
set, when the curved road is present in the traveling lane in the moving direction of the vehicle, the other estimated compartment line based on one of the first compartment lines and the second compartment line out of inner and outer sides of a curved road, and
reduce the comparison target distance when the degree of deviation between the other first compartment line and the estimated compartment line is equal to or less than a first threshold value.

As described above, although a form for performing the present invention has been described using the embodiment, the present invention is not limited to such an embodiment at all, and various modifications and substitutions can be applied within a range not departing from the concept of the present invention.

What is claimed is:

1. A vehicle control device comprising:
a memory storing a instructions; and
a processor configured to execute the instructions stored in the memory to:
recognize, as first compartment lines, compartment lines that compart left and right sides of a traveling lane of a vehicle based on an output of a first detection device that detects compartment lines around the vehicle;
recognize, as second compartment lines, compartment lines that compart the left and right sides of the traveling lane of the vehicle from map information, based on position information of the vehicle;
compare the first compartment lines with the second compartment lines at a predetermined comparison target distance in a moving direction of the vehicle; and
perform driving control of the vehicle based on a comparison result, wherein
the processor sets, when a curved road is present in the traveling lane in the moving direction of the vehicle, the other estimated compartment line based on one of the first compartment lines and the second compartment line out of inner and outer sides of a curved road, and reduces the comparison target distance when the degree of deviation between the other first compartment line and the estimated compartment line is equal to or less than a first threshold value.

2. The vehicle control device according to claim 1, wherein the processor sets the estimated compartment line on the inner side of the curved road, based on the first and second compartment lines on the outer side of the curved road.

3. The vehicle control device according to claim 2, wherein the processor sets the estimated compartment line based on a deviation amount of a distance viewed from the vehicle with respect to the first and second compartment lines on the outer side of the curved road, and derives the degree of deviation between the set estimated compartment line and the first compartment line on the inner side of the curved road.

4. The vehicle control device according to claim 3, wherein the processor derives a difference in height in a vertical direction of the curved road with respect to a current position of the vehicle based on the deviation amount of the distance viewed from the vehicle with respect to the first and second compartment lines on the outer side of the curved road, and derives a deviation between the first compartment line on the inner side of the curved road and the estimated compartment line based on the derived difference in height.

5. The vehicle control device according to claim 2, wherein the processor maintains the reduced comparison target distance when the degree of deviation is greater than the first threshold value and is equal to or less than a second threshold value that is greater than the first threshold value, and the comparison target distance has already been reduced.

6. The vehicle control device according to claim 5, wherein the processor returns the comparison target distance to the distance before it was reduced when the degree of deviation is greater than the second threshold value and is equal to or less than a third threshold value that is greater than the second threshold value.

7. The vehicle control device according to claim 6, wherein the processor, when the degree of deviation is greater than the third threshold value, returns the comparison target distance to the distance before it was reduced, and suppresses changes in the comparison target distance for a predetermined period.

8. The vehicle control device according to claim 1, wherein the processor further executes instructions to:
recognize objects around the vehicle based on an output of a second detection device different from the first detection device,
wherein the processor performs driving control of the vehicle based on a comparison result between the second compartment line and the object recognized when the degree of deviation is equal to or less than the first threshold value.

9. A vehicle control method comprising causing a computer to:
recognize, as first compartment lines, compartment lines that compart left and right sides of a traveling lane of a vehicle based on an output of a first detection device that detects compartment lines around the vehicle;
recognize, as second compartment lines, compartment lines that compart the left and right sides of the traveling lane of the vehicle from map information, based on position information of the vehicle;
compare the first compartment lines with the second compartment lines at a predetermined comparison target distance in a moving direction of the vehicle;
perform driving control of the vehicle based on a comparison result;
set, when the curved road is present in the traveling lane in the moving direction of the vehicle, the other estimated compartment line based on one of the first compartment lines and the second compartment line out of inner and outer sides of a curved road; and
reduce the comparison target distance when the degree of deviation between the other first compartment line and the estimated compartment line is equal to or less than a first threshold value.

10. A computer-readable non-transitory storage medium storing a program that causes a computer to:
recognize, as first compartment lines, compartment lines that compart left and right sides of a traveling lane of a vehicle based on an output of a first detection device that detects compartment lines around the vehicle;
recognize the compartment lines separating the left and right sides of the vehicle's lane from map information based on the vehicle's position information as second compartment lines;
compare the first compartment lines with the second compartment lines at a predetermined comparison target distance in a moving direction of the vehicle;
perform driving control of the vehicle based on a comparison result;
set, when the curved road is present in the traveling lane in the moving direction of the vehicle, the other estimated compartment line based on one of the first compartment lines and the second compartment line out of inner and outer sides of a curved road; and
reduce the comparison target distance when the degree of deviation between the other first compartment line and the estimated compartment line is equal to or less than a first threshold value.
